(19) United States
(12) Patent Application Publication
(10) Pub. No.: US 2003/0135434 A1
(43) Pub. Date: Jul. 17, 2003

(54) System and method for micro-payments

(76) Inventor: Ravi Jain, Placentia, CA (US)

Correspondence Address: KLEIN, O'NEILL & SINGH, SUITE 510, 2 PARK PLAZA, IRVINE, CA, 92614, US

(21) Appl. No.: 10/190,387

(22) Filed: Jul. 3, 2002

Related U.S. Application Data
(60) Provisional application No. 60/348,558, filed on Jan. 14, 2002.

(51) Int. Cl. G06F 17/60

(52) U.S. Cl. 705/34

(57) ABSTRACT

A method and system is provided for on-line transactions involving micro-payments. The method includes, paying a merchant for any goods and/or services purchased by a user, wherein a micro-payment system pays the merchant; and billing the user for the goods purchased, wherein a payment provider bills the user for the goods and services. The micro-payment system authorizes a user for transacting business with an authorized merchant and pays the merchant. The payment provider in the foregoing aspects of the present invention may be a telephone company, a cable company, Internet service provider, utilities company, Gas Company and/or any other entity that regularly bills the user for service(s).

### CROSS REFERENCE TO RELATED APPLICATIONS

This application is related to the provisional U.S. patent application entitled, “SYSTEM AND METHOD FOR MICRO-PAYMENTS”, Serial No. 60/348,558, filing date, Jan. 14, 2002, the disclosure of which is incorporated herein by reference, in its entirety.

### BACKGROUND OF THE INVENTION

1. Field of the Invention

The present invention relates to on-line business transactions, and more particularly to a system and method that facilitates micro-payments for on-line transactions.

2. Background

The advent of the Internet has dramatically changed today's modern life. A consumer (also referred to herein as a “user”) today can buy goods and services from any part of the world, without leaving the comfort of their homes. Today, one can use the Internet to purchase goods, services, music and videos, pay bills on-line and apply for mortgage loans.

Internet based commerce is typically referred to as “E-commerce”, where a transaction between a business and consumer takes place using computer terminals. In a typical E-commerce transaction, a user uses a computing device (computer, handheld device, cellular phone, or set-top box etc.) to access a merchant's web site. The consumer orders goods and/or services, and thereafter, an authorized credit card or bank account is charged.

E-commerce transactions today mostly involve a large sum of monies, at least greater than one dollar. However, there is a huge market for consumers and for businesses alike that are based on micro-payments (payments less than one dollar). For example, if one were to buy a few candies, or MP3 files, the present E-commerce system does not allow collection of such micro-payments efficiently.

Therefore, there is a need for a system and method that will allow a consumer to easily purchase goods and services of low monetary value, and efficiently pay the micro-payment(s) for the transactions.

### SUMMARY OF THE INVENTION

In one aspect of the present invention, a method is provided for on-line transactions. The method includes, paying a merchant for any goods and/or services purchased by a user, wherein a micro-payment system pays the merchant and a payment provider bills the user for the goods and services.

In another aspect of the present invention, a system for on-line transaction is provided. The system includes a micro-payment system module, wherein the micro-payment system authorizes a user for conducting business with an authorized merchant and pays the merchant; and a payment provider system module that is authorized by the micro-payment system module to bill the user for any goods/and/or services purchased by the authorized user from the authorized merchant.

In another aspect of the present invention, a computer-readable medium storing computer-executable process steps for use in a computer system for on-line transactions is provided. The process steps include paying a merchant for any goods and/or services purchased by a user, wherein the micro-payment system pays the merchant. The payment provider may also bill the user for the goods and services.

In another aspect of the present invention, computer-executable process steps for use in a computer system for on-line transactions are provided. The process steps include, paying a merchant for any goods and/or services purchased by a user, wherein the micro-payment system pays the merchant; and billing the user for the goods purchased, wherein the payment provider bills the user for the goods and services.

The payment provider in the foregoing aspects of the present invention may be a telephone company, a cable company, Internet service provider, utilities company, Gas Company and/or any other entity that regularly bills the user for service(s).

In one aspect of the present invention, micro-payment based transactions are efficiently conducted because a payment provider who regularly bills a user for other service(s) also includes the micro-payment charges on the same bill.

In another aspect of the present invention, families may provide a virtual card to their children and monitor spending.

In yet another aspect of the present invention, low-income families can purchase goods on-line using the micro-payment system.

This brief summary has been provided so that the nature of the invention may be understood quickly. A more complete understanding of the invention can be obtained by reference to the following detailed description of the preferred embodiments thereof, in connection with the attached drawings.

### BRIEF DESCRIPTION OF THE DRAWINGS

FIG. 1 is a block diagram of a computing system that may be used to execute computer executable process steps according to one aspect of the present invention.

FIG. 2 is a block diagram showing the internal functional architecture of the computer system in FIG. 1.

FIG. 3 shows plural computers connected to the Internet, to execute process steps according to one aspect of the present invention.

FIG. 4A is a block diagram of the overall micro-payment system, according to one aspect of the present invention.

FIG. 4B is a block diagram showing various components of the micro-payment system, according to one aspect of the present invention.

FIG. 4C is a block diagram showing various components of a payment provider system, according to one aspect of the present invention.

FIG. 4D is a block diagram showing various components of an authorized merchant system, according to one aspect of the present invention.

FIG. 5 is a flow diagram of computer-executable process steps for creating an account for a user with the micro-payment system, according to one aspect of the present invention.

FIG. 6 is a flow diagram of computer-executable process steps for creating an account for a payment provider with the micro-payment system, according to one aspect of the present invention.

FIG. 7 is a flow diagram of computer-executable process steps for creating an account for a merchant with the micro-payment system, according to one aspect of the present invention.

FIG. 8 is a flow diagram of computer-executable process steps for creating a user account through a payment provider system and/or authorized merchant system, according to one aspect of the present invention.

FIG. 9 is a flow diagram of computer-executable process steps showing user, merchant and payment provider transactions using the micro-payment system, according to one aspect of the present invention.

FIG. 10 is a flow diagram of process steps involved in a cash card transaction between a user and merchant using the micro-payment system, according to one aspect of the present invention.

Features appearing in multiple figures with the same reference numeral are the same unless otherwise indicated.

### DETAILED DESCRIPTION OF THE PREFERRED EMBODIMENTS

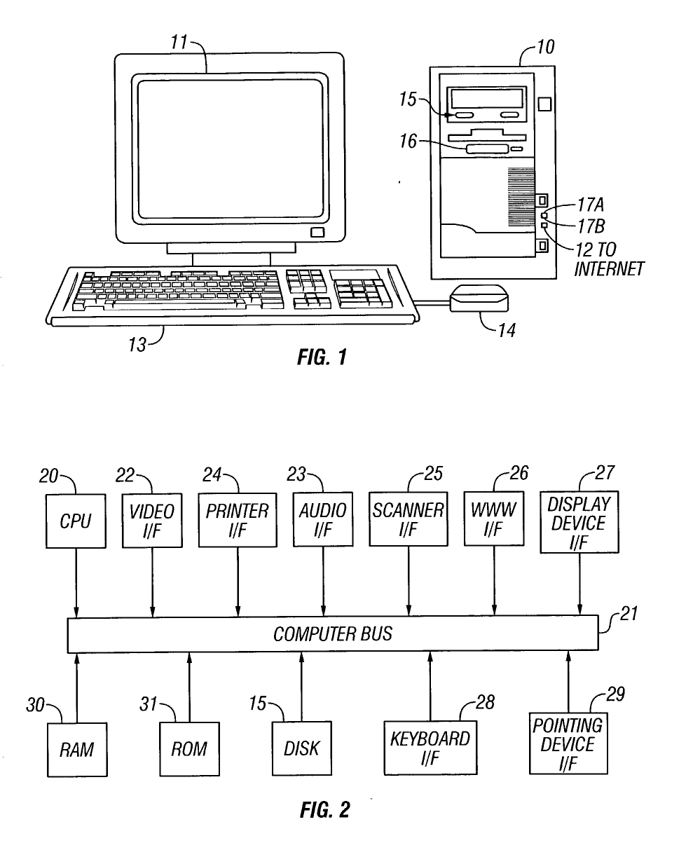

FIG. 1 is a block diagram of a computing system for executing computer executable process steps according to one aspect of the present invention. FIG. 1 includes a host computer 10 and a monitor 11. Monitor 11 may be a CRT type, a LCD type, or any other type of color or monochrome display. Also provided with computer 10 are a keyboard 13 for entering data and user commands, and a pointing device 14 for processing objects displayed on monitor 11.

Computer 10 includes a computer-readable memory medium such as a rotating disk 15 for storing readable data. Besides other programs, disk 15 can store application programs including web browsers by which computer 10 connects to the Internet and the systems described below.

According to one aspect of the present invention, computer 10 can also access computer-readable floppy disks storing data files, application program files, and computer executable process steps embodying the present invention or the like via a floppy disk drive 16. A CD-ROM, or CD R/W (read/write) interface (not shown) may also be provided with computer 10 to access application program files, audio files and data files stored on a CD-ROM.

A modem, an integrated services digital network (ISDN) connection, or the like also provides computer 10 with an Internet connection 12 to the World Wide Web (WWW). The Internet connection 12 allows computer 10 to download data files, audio files, movies, video, application program files and computer-executable process steps embodying the present invention, and conduct on-line E-commerce transactions.

Computer 10 is also provided with external audio speakers 17A and 17B to assist a listener to listen to audio files either on-line downloaded from the Internet, or off-line using a CD.

It is noteworthy that the present invention is not limited to the FIG. 1 architecture. For example, notebook or laptop computers, handheld devices, set-top boxes or any other system capable of running computer-executable process steps, as described below, may be used to implement the various aspects of the present invention.

FIG. 2 is a block diagram showing the internal functional architecture of computer 10. As shown in FIG. 2, computer 10 includes a CPU 20 for executing computer-executable process steps and interfaces with a computer bus 21. Also shown in FIG. 2 are a video interface 22, an audio interface 23, a printer interface 24, a scanner interface 25, a WWW interface 26, a display device interface 27, a keyboard interface 28, a pointing device interface 29, and a rotating disk 15.

Audio interface 23 allows a listener to listen to music, on-line (downloaded using the Internet or a private network) or off-line (using a CD), and video interface 22 allows a user to access video and/or movies. Printer interface 24 and scanner interface 25 provide computer 10 with connectivity to a scanner and printer (not shown).

As described above, disk 15 stores operating system program files, application program files, web browsers, and other files. Some of these files are stored on disk 15 using an installation program. For example, CPU 20 executes computer-executable process steps of an installation program so that CPU 20 can properly execute the application program.

Random access memory (“RAM”) 30 also interfaces to computer bus 21 to provide CPU 20 with access to memory storage. When executing stored computer-executable process steps from disk 15 (or other storage media such as floppy disk 16 or WWW connection 12), CPU 20 stores and executes the process steps out of RAM 30.

Read only memory (“ROM”) 31 is provided to store invariant instruction sequences such as start-up instruction sequences or basic input/output operating system, (BIOS) sequences for operation of keyboard 13.

Computer-executable process steps, according to one aspect of the present invention may be performed using the Internet. The following provides a brief description of the Internet.

The Internet connects thousands of computers world wide through well-known protocols, for example, Transmission Control Protocol (TCP)/Internet Protocol (IP), into a vast network. Information on the Internet is stored world wide as computer files, mostly written in the Hypertext Mark Up Language (“HTML”). Other mark up languages, e.g., Extensible Markup Language as published by W3C Consortium, Version 1, Second Edition, October 2000, ©W3C may also be used. The collection of all such publicly available computer files is known as the World Wide Web (WWW). The WWW is a multimedia-enabled hypertext system used for navigating the Internet and is made up of hundreds of thousands of web pages with images and text and video files, which can be displayed on a computer monitor. Each web page can have connections to other pages, which may be located on any computer connected to the Internet.

A typical Internet user uses a client program called a “Web Browser” to connect to the Internet. A user can connect to the Internet via a proprietary network, such as America Online or CompuServe, or via an Internet Service Provider, e.g., Earthlink. The web browser may run on any computer connected to the Internet. Currently, various browsers are available of which two prominent browsers are Netscape Navigator and Microsoft Internet Explorer. The Web Browser receives and sends requests to a web server and acquires information from the WWW. A web server is a program that, upon receipt of a request, sends the requested data to the requesting user. A standard naming convention known as Uniform Resource Locator (“URL”) has been adopted to represent hypermedia links and links to network services. Most files or services can be represented with a URL.

URLs enable Web Browsers to go directly to any file held on any WWW server. Information from the WWW is accessed using well-known protocols, including the Hypertext Transport Protocol (“HTTP”), the Wide Area Information Service (“WAIS”) and the File Transport Protocol (“FTP”), over TCP/IP protocol. The transfer format for standard WWW pages is Hypertext Transfer Protocol (HTTP).

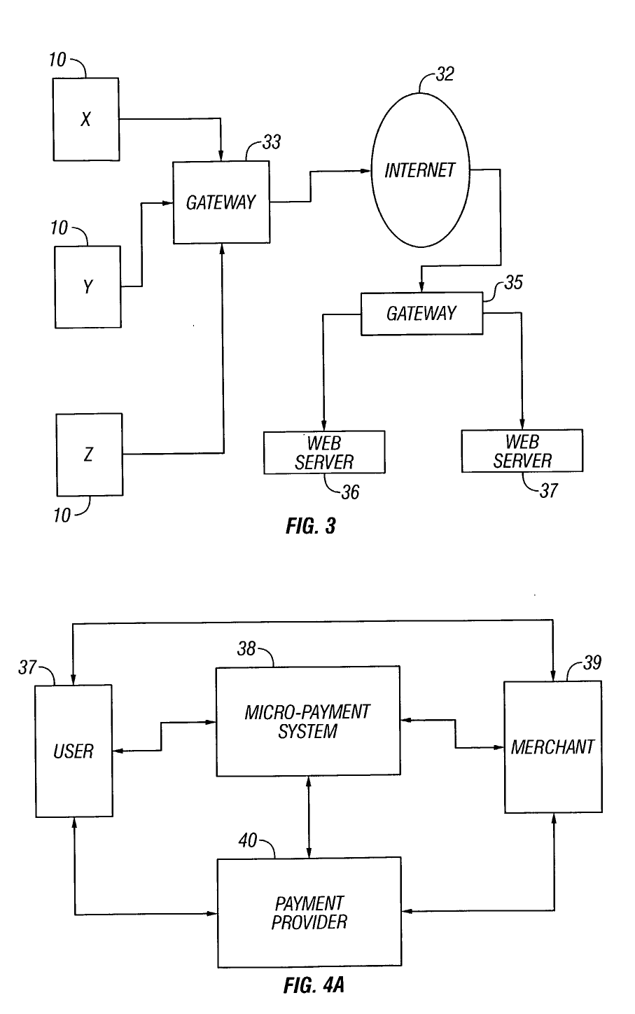

FIG. 3 shows a typical topology of a computer network with computers similar to computer 10, connected to the Internet. For illustration purposes, three computers X, Y and Z are shown connected to the Internet 32 via WWW interface 26 through a gateway 33, where gateway 33 can interface N number of computers.

WWW interface 26 may be a modem, network interface card or a unit for providing connectivity to other computer systems over a network using protocols such as X.25, Ethernet or TCP/IP, or any device that allows, directly or indirectly, computer-to-computer communications. It is noteworthy that the invention is not limited to a particular number of computers. Any number of computers that can be connected to the Internet 32 or any other computer network may be used.

FIG. 3 further shows a second gateway 35 that connects a network of web servers 36 and 37 to the Internet 32. Web servers 36 and 37 may be connected with each other over a computer network. A business entity may host a web site on web servers 36 and 37 allowing users to purchase goods and/or services using the system described below.

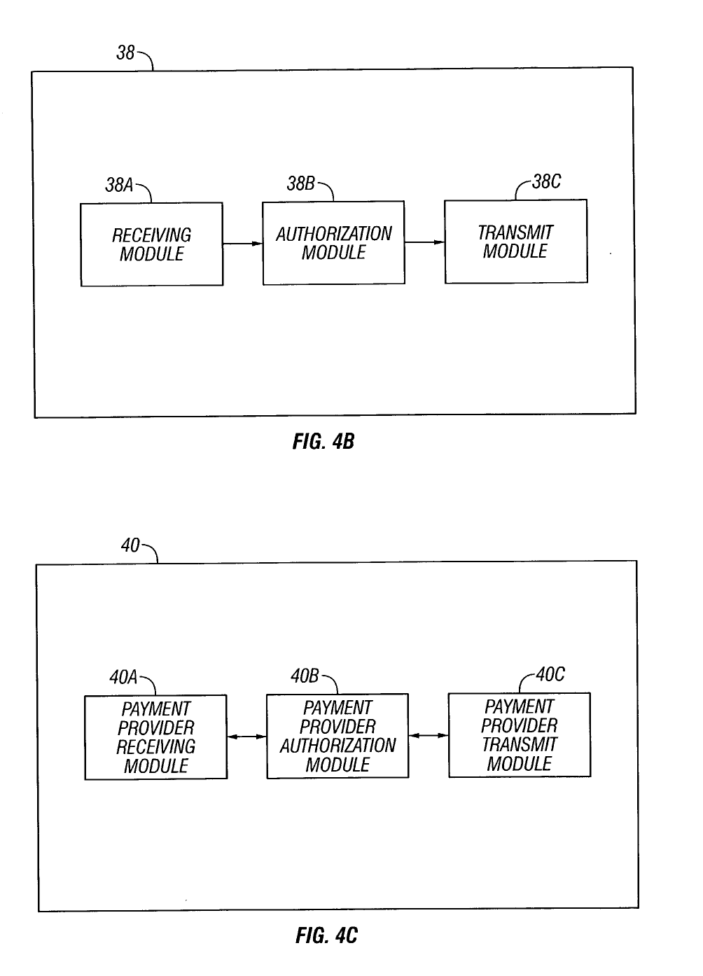

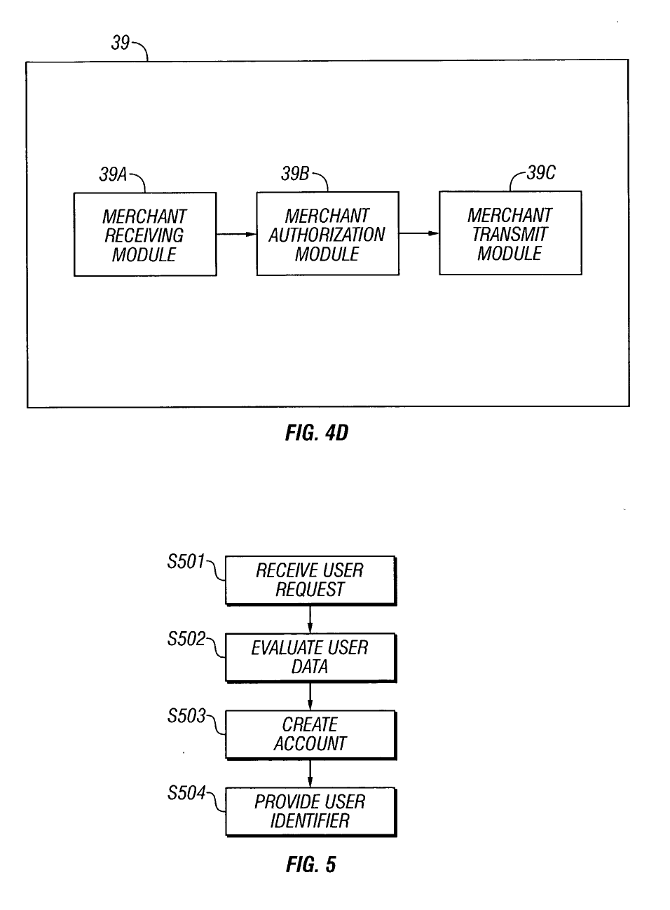

FIG. 4A is a block diagram according to one aspect of the present invention showing interaction between various components of the present system. It is noteworthy that the term user 37 herein includes a user and/or the user computer, a business entity or individual (referred to herein as “merchant system 39”) includes the merchant and/or the merchant computer system (for example, a website hosted on web servers 36 and/or 37), and payment provider system 40 includes the payment provider and/or payment provider computer system (for example, a system hosted on web servers 36 and/or 37), as applicable. User 37, merchant system 39, payment provider system 40 and/or micro-payment system 38, according to one aspect of the present invention, may use computer 10 described above.

User 37 registers itself with micro-payment system 38 and receives a unique identifier that authorizes user 37 to conduct a business transaction. User 37 uses the unique identifier to conduct E-commerce transactions via micro-payment system 38. User 37 may register itself with micro-payment system 38 using payment provider system 40 who is authorized by the micro-payment system 38 to bill authorized users (that may include consumers, business entities or the like).

Merchant system 39 also registers itself with the micro-payment system 38 and receives a unique identifier from micro-payment system 38. Merchant system 39 registration allows merchant system 39 to conduct business transactions with user 37 who is pre-registered and approved.

Payment provider system 40 is also be coupled to micro-payment system 38. Payment provider system 40 may be a telephone company that provides and/or bills user 37 for telephone services; a cable company that provides and/or bills user 37 for cable services; an Internet Service Provider that provides and/or bills user 37 for Internet services, or a utilities company that provides gas, water and/or electricity services and bills user 37 for it. It is noteworthy that the foregoing examples of payment provider system 40 are only to illustrate one aspect of the present invention; various other similar entities may be used to act as payment provider system 40 under the present micro-payment system 38.

Payment provider system 40 may be pre-approved by micro-payment system 38 to register user 37 directly, and authorize user 37 to conduct business transactions using the unique identifier. For example, user 37 may apply for registration with micro-payment system 38 through payment provider system 40. Hence, user 37 may apply directly to, for example, its telephone company that is registered with micro-payment system 38 to receive a unique identifier for conducting business transactions and be billed by payment provider system 40, in this example, the telephone company.

To purchase goods and services, user 37 accesses merchant system 39 and selects certain goods and/or services. User 37 transmits the unique identifier to merchant system 39. Merchant computer 39 authenticates user 37 provided unique identifier with micro-payment system 38. Micro-payment system 38 authenticates the unique identifier and merchant system 39 completes the transaction by delivering the goods and/or services to user 37.

In another aspect of the present invention, merchant system 39 has all the authorized data from micro-payment system 38 on a real time basis and can hence self authorize a user 37 request for business transaction(s).

Micro-payment system 38 and merchant system 39 may optionally have an arrangement under which merchant system 39 provides a certain discount if user 37 purchases any goods and/or services using micro-payment system 38.

In one aspect of the present invention, merchant system 39 transmits the business transaction information with user 37 to payment provider system 40. Payment provider system 40 verifies the business transaction with micro-payment system 38 and simultaneously bills user 37 via the regular service bill that payment provider system 40 provides to user 37.

In another aspect of the present invention, micro-payment system 38 provides user 37 transaction data to payment provider 40, who then directly bills user 37.

In another aspect of the present invention, payment provider system 40 has real-time information regarding an authorized merchant 39 and user 37 and does not need to verify with micro-payment system 38. For example, every time a user or merchant registers with micro-payment system 38, it may forward the unique user identifier and merchant identifier to payment provider system 40.

User 37 pays payment provider system 40 for goods and/or services. Payment provider system 40 forwards the payment to micro-payment system 38. Payment provider system 40 can forward every individual payment from user 37 or consolidate various payments from one or more users and then forward the consolidated payment to micro-payment system 38. The consolidated payment includes plural transactions of various or one user with merchant system 39.

Micro-payment system 38 pays merchant 39 after it receives payment from payment provider 40.

FIG. 4B is a block diagram showing various components of micro-payment system 38. Turning in detail to FIG. 4B, micro-payment system 38 includes a receiving module 38A, an authorization module 38B and a transmitting module 38C. Receiving module 38A receives information from merchant system 39, user 37 and/or payment provider system 40 and transmits the same to the authorization module 38B. Authorization module 38B authenticates the information as provided and transmits the same to transmitting module 38C. Transmitting module 38C transmits the information to user 37, merchant system 39 and/or payment provider system 40 as the case may be.

FIG. 4C is a block diagram, which shows various components of payment provider system 40, according to one aspect of the present invention. Payment provider system 40 includes a payment provider receiving module 40A, a payment provider authorization module 40B and a payment provider transmitting module 40C. Payment provider receiving module 40A receives information from user 37, merchant system 39 and micro-payment system 38 and forwards the same to payment provider authorization module 40B. Payment provider authorization module 40B stores information on user 37 transactions and bills user 37 for them. Payment provider transmitting module 40C transmits information to user 37, merchant system 39 and/or or micro-payment system 38 as discussed below.

FIG. 4D is a block diagram, which shows various components of merchant system 39, according to one aspect of the present invention. Merchant system 39 includes a merchant receiving module 39A, a merchant authorization module 39B and a merchant transmitting module 39C. Merchant receiving module 39A receives user 37 request for business transactions, and forwards the same to merchant authorization module 39B. Merchant authorization module 39B authorizes the transaction (either by information stored or using micro-payment system 38). Merchant transmitting module 39C transmits data, as discussed below to user 37, micro-payment system 38, and/or or payment provider system 40, as discussed below.

It is noteworthy that the invention is not limited to the foregoing modules for micro-payment system 38, merchant system 39 and payment provider system 40. The foregoing modules may be combined in plural ways to execute the computer-executable process steps, according to the various aspects of the present invention. For example, all the three modules for micro-payment system 38, merchant system 39 and/or payment provider system 30 may be combined into one, or more than one module. Also, micro-payment system 38 and payment provider system 40 may be combined into a single module. Similarly, merchant system 39 and micro-payment system 38 may be combined into a single module. These combinations are again to illustrate the various adaptive aspects of the present invention and are not intended to limit the invention to any particular configuration.

FIG. 5 is a flow diagram showing computer-executable process steps according to one aspect of the present invention for registering user 37.

Turning in detail to FIG. 5, in step S501, user 37 transmits a request to micro-payment system 38 for registration. This request may be sent using computer 10 via a web-browser. Typically, user 37 will provide contact information, including telephone, address, and a preferred payment provider, if applicable. Receiving module 38A receives user 37 request for registration.

In step S502, micro-payment system 38 evaluates user 37 request. The evaluation may be performed by authorization module 38B and may include verifying payment provider information.

In step S503, micro-payment system 38 sets up a user 37 account and in step S504, a unique identifier is provided to user 37. Authorization module 38B may provide the unique identifier and transmitting module 38C transmits the unique identifier to user 37. Typically, as is well known to one skilled in the art, such transmission may be secured used SSL encryption technology.

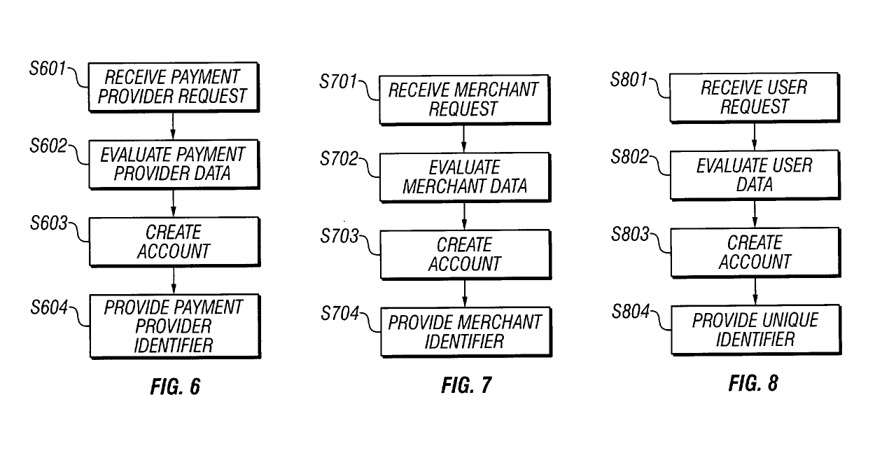

FIG. 6 shows a flow diagram of computer-executable process steps for setting up a payment provider system 40 account with the micro-payment system 38, according to one aspect of the present invention.

In step S601, micro-payment system 38 receives a request from payment provider system 40. Payment provider transmitting module 40C sends the request to micro-payment system receiving module 38A for registration as a payment provider with micro-payment system 38. This registration enables payment provider system 40 to bill authorized user 37, and act as an intermediary between merchant system 39 and user 37, if desired.

In step S602, authorization module 38B evaluates payment provider system 40 request. Typically, this includes verifying contact and other information required for an account set up.

In step S603, micro-payment system 38 through authorization module 38B sets up a payment provider account. Such an account may provide varying degrees of authority, for example, one payment provider may have all the privileges including billing a user, and allowing users to register directly with the payment provider, and others may be allowed to only bill the user.

In step S604, micro-payment system 38 provides a unique identifier to payment provider system 40. Transmitting module 38C sends the unique identifier to payment provider receiving module 40A.

FIG. 7 shows a flow diagram of computer-executable process steps for setting up a merchant system 39 account with micro-payment system, according to one aspect of the present invention.

In step S701, micro-payment system 38 receives a request from merchant system 39. Merchant transmitting module 39C sends a request to receiving module 38A for registration as an authorized merchant with micro-payment system 38. This registration enables merchant system 39 to transact business with authorized users like user 37, and/or sell cash cards to any user, as discussed below.

In step S702, authorization module 38B evaluates merchant system 39 requests. Typically, this includes verifying contact and other information required for an account set up.

In step S703, micro-payment system 38 via authorization module 38B sets up a merchant system 39 account. Such an account may provide varying degrees of authority, for example, one merchant may have all the privileges including selling goods and/or services, allowing a user to register with the micro-payment system 38, and sell cash cards. Others may only be allowed to sell goods and/or services.

In step S704, micro-payment system 38 provides a unique identifier to merchant system 39. Transmitting module 38C sends the unique identifier to merchant receiving module 39A.

FIG. 8 shows a flow diagram of computer-executable process steps for setting up a user account 37 with micro-payment system 38 through either a payment provider system 40 or merchant system 39, according to one aspect of the present invention.

In step S801, payment provider system 40 receives a request from user 37 for registration. In another aspect of the present invention, merchant system 39 may register user 37. Payment provider receiving module 40A (or merchant receiving module 39A, as the case may be) receives user 37 requests.

In step S802, payment provider authorization module 40B (or merchant authorization module 39B) evaluates user 37 requests. Typically, this includes verifying contact and other information required for an account set up.

In step S803, payment provider system 40 (or merchant system 39) through payment provider transmitting module 40C transmits user 37 information to micro-payment system 38.

In step S804, payment provider system 40 (and/or merchant system 39) provides the unique identifier to user 37. Payment provider transmitting module 38C sends the unique identifier to user 37. This allows user 37 to use payment provider system 40 for billing, and/or merchant system 39 for business transactions.

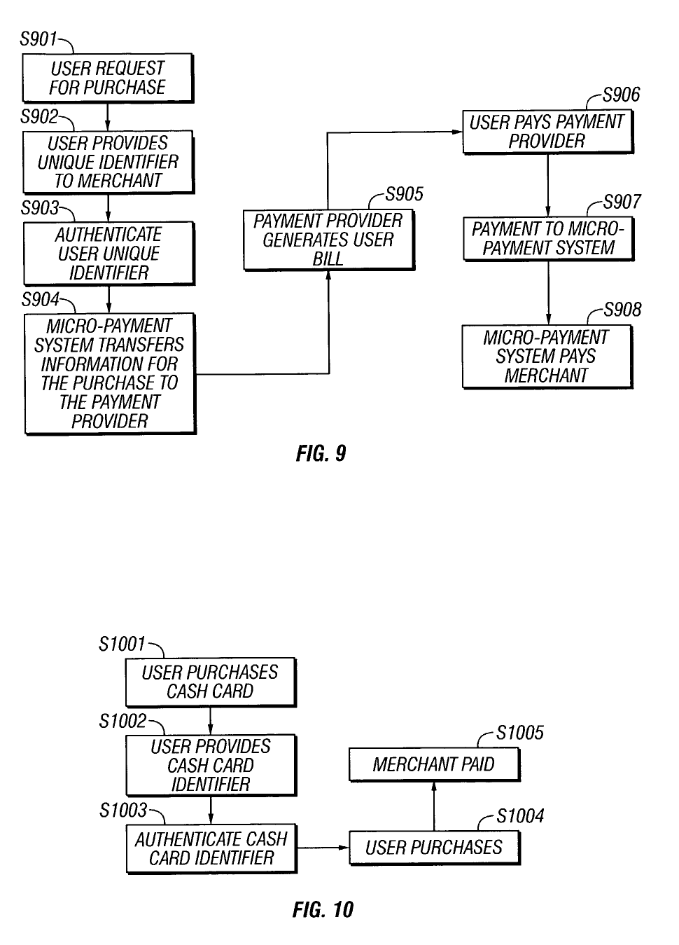

FIG. 9 is a flow diagram of computer executable process steps involved in transactions between user 37, merchant system 39, micro-payment system 38 and payment provider system 40.

In step S901, user 37 purchases goods and/or services from merchant system 39. This transaction may be executed from a computing device (e.g. computer 10) coupled to Internet 32. User 37 may place an order from a merchant 39 website (not shown).

In step S902, user 37 provides the micro-payment system unique identifier to merchant system 39. Merchant receiving module 39A receives user 37 unique identifier.

In step S903, merchant transmitting module 39B sends user 37 unique identifier to micro-payment system 38. Receiving module 38A receives the unique identifier. Micro-payment system 38 authenticates user 37 unique identifier. Authorization module 38B verifies user 37 unique identifier. Transmitting module 38C transmits an authentication packet to merchant receiving module 39A. If user 37 unique identifier is authenticated by micro-payment system 38, the transaction moves forward towards execution. If the unique identifier is not authenticated, user 37 is notified and the transaction ends.

In another aspect of the present invention, merchant system 39 directly authenticates the user 37 unique identifier. This is made possible because merchant system 39 may be coupled with micro-payment system 38 and receives all real time user 37 information, including unique identifier data. Merchant system 39 may be allowed to authenticate user request based upon the level of authority that micro-payment system 38 provides to merchant system 39, as discussed above.

In step S904, merchant system 39 provides any applicable discounts to micro-payment system 38. This may be based on an agreement between micro-payment system 38 and merchant system 39.

In step S905, micro-system system 38 transmits transaction information to payment provider system 40. Micro-system transmitting module 38C transmits the information needed to generate a bill for user 37. This includes, user identification data, nature of goods and/or services that are bought. In another aspect of the present invention, payment provider system 40 is coupled to micro-payment system 38 in real time and may be able to access data on user 37 and/or merchant system 39. This allows payment provider system 40 to generate bills.

In another aspect of the present invention, merchant system 39 transmits transaction information to payment provider system 40. Thereafter, payment provider system 40 verifies merchant system 39 information and/or user 37 data with micro-payment system 38 to generate user bills.

Payment provider system 40 bill may be included with the payment provider system 40's regular services bill, for example, the telephone, cable, Internet services, utilities and other similar bills. Payment provider system 40 matches user 37 unique identifier and adds the transaction cost to user 37's existing bill. Thereafter, user 37 pays payment provider 40 for the goods and/or services.

In step S906, user 37 pays payment provider 40.

In step S907, payment provider system 40 forwards the payment it receives from user 37 to micro-payment system 38. Payment provider system 40 can forward every individual payment from user 37 or consolidate various payments from one or more users and then forward the consolidated payment to micro-payment system 38. The consolidated payment includes plural transactions of various or one user with merchant system 39. Micro-payment system 38 pays merchant 39 after it receives payment from payment provider 40.

In step S908, micro-payment system 38 pays merchant 39 for the transaction. It is noteworthy that user 37 payment to payment provider system 40 and micro-payment system 38 payments to merchant 39 may occur simultaneously.

FIG. 10 shows a flow diagram of process steps of yet another aspect of the present invention. Process steps include user 37 directly purchasing a cash card (“micro-card”). The micro-card may be purchased from micro-payment system 38 authorized merchant(s) 39 or directly from micro-payment system 38. Micro-payment system 38 activates the micro-card prior to any transaction and a user specific password may be provided to user 37.

User 37 on purchasing an item from merchant system 39 supplies the micro-card number and/or password to authorized merchant 39. Merchant system 39 then transmits micro-card data to micro-payment system 38 for authorization. The micro-card is debited for the amount of purchase and user 37 may use the balance to purchase other goods. Micro-payment system 38 electronically transfers the amount owed to merchant system 39 for the purchase. If merchant 39 and user 37 are in two different countries user 37 is debited in its native currency and merchant 39 collects in its native currency.

Turning now in detail to FIG. 10, in step S1001, user 37 purchases a micro-card. Such a micro-card may be purchased from authorized merchant 39 or micro-payment system 38. If micro-card is bought from micro-payment system 38, then receiving module 38A receives such purchase requests and authorization module 38B authorizes the purchase. Transmitting module 38C transmits a user 37 password and/or micro-card unique identifier to user 37.

If the micro-card is purchased from authorized merchant 39, then user 37 transmits a card activation request to merchant receiving module 39A. Activation request is forwarded to authorization module 38B and a unique password may be transmitted to user 37. Merchant transmitting module 39C transmits the password and/or card activation information to user 37. This may be via electronic mail, telephone message or real time.

In step S1002, user 37 purchases goods from authorized merchant 39. User 37 provides micro-card information to merchant system 39. Merchant receiving module 39A receives the micro-card information for an on-line transaction. User 37 may also purchase goods and/or services from a brick and mortar (traditional business store or establishment) using the micro-card.

In step S1003, merchant transmitting module 39C transmits micro-card data to micro-payment system 38. Receiving module 38A receives micro-card information from merchant transmitting module 39C. Micro-card data is then sent to authorization module 38B that authenticates and approves any cash debits. Authorization 38B maintains a running total on the micro-card, which is the cash available for user 37 to purchase goods and/or services.

In another aspect of the present invention, merchant system 39 is coupled to micro-payment system 38 directly and is authorized to maintain real time accounting on the micro-card. Hence in this case, user 37 requests for using a cash card does not require micro-payment system 38 approval. Instead, merchant system 39 informs micro-payment system 38 of any transactions.

In step S1004, after user 37 micro-card is authorized for a certain purchase, user 37 purchases the goods and/or services.

In step S1005, micro-payment system 38 electronically transfers the transaction amount to merchant system 39. In another aspect of the present invention, micro-payment system 38 may pay merchant system 39 by traditional means, for example, checks or electronic fund transfer.

In one aspect of the present invention, micro-payment based transactions are efficiently conducted because a payment provider who regularly bills a user for other service(s) also includes the micro-payment charges on the same bill.

In another aspect of the present invention, families may provide a virtual card to their children and monitor spending.

In yet another aspect of the present invention, low-income families can purchase goods on-line using the micro-payment system.

While the present invention is described above with respect to what is currently considered its preferred embodiments, it is to be understood that the invention is not limited to that described above. To the contrary, the invention is intended to cover various modifications and equivalent arrangements within the spirit and scope of the appended claims.

What is claimed is:

1. A method for on-line transaction, comprising:
paying a merchant for any goods and/or services purchased by a user, wherein a micro-payment system pays the merchant; and
billing the user for the goods purchased, wherein a payment provider bills the user for the goods and/or services.

2. The method of claim 1, wherein the payment provider may be a telephone company.

3. The method of claim 1, wherein the payment provider may be a cable company.

4. The method of claim 1, wherein the payment provider may be a gas company.

5. The method of claim 1, wherein the payment provider may be a utilities company.

6. The method of claim 1, wherein the payment provider may be an Internet Service Provider.

7. The method of claim 1, wherein the payment provider is any business entity that bills the user for any service.

8. The method of claim 1, wherein the goods and/or services may be valued at less than a dollar.

9. A system for on-line transactions, comprising of:
a micro-payment system module, wherein the micro-payment system authorizes a user for transacting business with an authorized merchant; and
a payment provider that is authorized by the micro-payment system module to bill the user for any goods and/or services purchased by the user from the authorized merchant.

10. The system of claim 9, wherein the payment provider may be a telephone company.

11. The system of claim 9, wherein the payment provider may be a cable company.

12. The system of claim 9, wherein the payment provider may be a gas company.

13. The system of claim 9, wherein the payment provider may be a utilities company.

14. The system of claim 9, wherein the payment provider may be an Internet Service Provider.

15. The system of claim 9, wherein the payment provider is any business entity that bills the user for any service.

16. The system of claim 9, wherein the goods and/or services may be valued at less than a dollar.

17. The system of claim 9, wherein micro-payment module pays the merchant for the goods and/or services purchased.

18. A computer-readable medium storing computer-executable process steps of a process for use in a computer system for on-line transactions, comprising of:
paying a merchant for any goods and/or services purchased by a user, wherein a micro-payment system pays the merchant; and
billing the user for the goods purchased, wherein a payment provider bills the user for the goods and/or services.

19. The computer readable medium of claim 18, wherein the payment provider may be a telephone company.

20. The computer readable medium of claim 18, wherein the payment provider may be a cable company.

21. The computer readable medium of claim 18, wherein the payment provider may be a gas company.

22. The computer readable medium of claim 18, wherein the payment provider may be a utilities company.

23. The computer readable medium of claim 18, wherein the payment provider may be an Internet Service Provider.

24. The computer readable medium of claim 18, wherein the payment provider is any business entity that bills the user for any service.

25. The computer readable medium of claim 18, wherein the good and/or services may be valued at less than a dollar.

26. Computer-executable process steps for on-line transactions, comprising:
paying a merchant for any goods and/or services purchased by a user, wherein a micro-payment system pays the merchant; and
billing the user for the goods purchased, wherein a payment provider bills the user for the goods and/or services.

27. Computer-executable process steps of claim 26, wherein the payment provider may be a telephone company.

28. Computer-executable process steps of claim 26, wherein the payment provider may be a cable company.

29. Computer-executable process steps of claim 26, wherein the payment provider may be a gas company.

30. Computer-executable process steps of claim 26, wherein the payment provider may be a utilities company.

31. Computer-executable process steps of claim 26, wherein the payment provider may be an Internet Service Provider.

32. Computer-executable process steps of claim 26, wherein the payment provider is any business entity that bills the user for any service.

33. Computer-executable process steps of claim 26, wherein the goods and/or services may be valued at less than a dollar.
